(19) United States
(12) Patent Application Publication
(10) Pub. No.: US 2003/0235180 A1
(43) Pub. Date: Dec. 25, 2003

(54) Method and apparatus for efficient channel assignment

(76) Inventors: Valentin Oprescu-Surcobe, Northbrook, IL (US); Sean S. Kelley, Hoffman Estates, IL (US)

Correspondence Address: MOTOROLA, INC., 1303 EAST ALGONQUIN ROAD, IL01/3RD, SCHAUMBURG, IL, 60196

(21) Appl. No.: 10/413,231

(22) Filed: Apr. 14, 2003

Related U.S. Application Data
(60) Provisional application No. 60/375,681, filed on Apr. 26, 2002.

(51) Int. Cl. H04B 7/212

(52) U.S. Cl. 370/348; 455/450

(57) ABSTRACT

To address the need for efficiently performing channel assignment in a manner that reduces call setup time, the present embodiments provide an abbreviated channel assignment message (300) that references information stored by a remote unit (113). The information that is referenced can be removed from the message. By shrinking the channel assignment message in this manner, the present embodiment allows it to be transmitted in a paging slot without negatively impacting the battery life of listening units. Thus, the reduced-call-setup-time benefit of transmitting a channel assignment message in a paging slot can be realized without trading off battery life.

### REFERENCE(S) TO RELATED APPLICATION(S)

The present application claims priority from U.S. provisional application, Serial No. 60/375681, entitled “METHOD AND APPARATUS FOR EFFICIENT CHANNEL ASSIGNMENT,” filed Apr. 26, 2002, which is commonly owned and incorporated herein by reference in its entirety.

This application is related to a co-pending application entitled “METHOD AND APPARATUS FOR REDUCING CALL SETUP TIME,” filed on even date herewith, assigned to the assignee of the instant application, and hereby incorporated by reference.

This application is related to a co-pending application, Ser. No. 10/303255, entitled “METHOD FOR EXPEDITING TRANSITIONS BETWEEN STATES OF OPERATION IN COMMUNICATIONS EQUIPMENT,” filed on Nov. 25, 2002, and assigned to the assignee of the instant application.

This application is related to a co-pending application, Ser. No. 09/887172, entitled “DISPATCH CALL ORIGINATION AND SET UP IN A CDMA MOBILE COMMUNICATION SYSTEM,” filed on Jun. 22, 2001, and assigned to the assignee of the instant application.

This application is related to a co-pending application, Ser. No. 10/108405, entitled “METHOD AND APPARATUS FOR WIRELESS DATA TRANSFER WITH REDUCED DELAY,” filed on Mar. 28, 2002, and assigned to the assignee of the instant application.

This application is related to a co-pending application, Ser. No. 10/108783, entitled “METHOD AND APPARATUS TO REDUCE WIRELESS DATA TRANSFER DELAY,” filed on Mar. 28, 2002, and assigned to the assignee of the instant application.

### FIELD OF THE INVENTION

The present invention relates generally to communication systems and, in particular, to efficient channel assignment in communication systems.

### BACKGROUND OF THE INVENTION

Dispatch communication services are not yet provided on CDMA-based communication systems. Unlike the interconnect services provided by today's cellular systems, dispatch services have been traditionally provided by two-way radio systems. Such services allow a user to communicate in ways that are difficult or costly using today's cellular systems. The dispatch group call service, for example, enables a user to communicate with a group of people simultaneously and instantaneously, usually just by depressing a push-to-talk (PTT) button. Using a cellular system, such a call could not occur instantaneously since either telephone numbers would need to be dialed for a three-way call or arrangements would need to be made to setup a conference call.

Likewise, the dispatch individual (typically called a private call) call service enables a user to communicate with another user quickly and spontaneously. This feature is ideal for two people who are working together but are unable to speak with one another directly such as two people working in concert but in different parts of a building. Where a wireless telephone call is more appropriate for a conversation, short messages between two people as they work are better facilitated by the dispatch individual call service.

Because of the instantaneous nature of dispatch communication, low delay is a critical factor for dispatch calls. For example, delay that is acceptable for a typical interconnect voice call, can be unacceptable for dispatch services which rely on a very fast connection being made to the called party. Therefore, the time it takes to setup a dispatch call is critical. Low delay (or latency) is also critical when establishing and re-establishing data sessions.

One proposal to shorten this call setup procedure is to page with a channel assignment message. Thus, upon receiving such a channel assignment message, the target mobile jumps to the assigned traffic channel. This approach has the benefit of reducing the time from when a page/channel assignment is sent to the mobile until the mobile is on the traffic channel. However, channel assignment messages are significantly longer than paging messages. Many inactive mobiles awake from their power saving mode to listen to their common paging slot. If channel assignment messages are transmitted in place of paging messages, mobiles will need to awaken for a longer period of time and thus use more power. This will substantially reduce their battery life.

Therefore, a need exists for a method and apparatus to efficiently perform channel assignment in a manner that reduces call setup time.

### BRIEF DESCRIPTION OF THE DRAWING

FIG. 1 is a block diagram depiction of a communication system in accordance with an embodiment of the present invention.

FIG. 2 is a block diagram depiction of a broadcast message in accordance with an embodiment of the present invention.

FIG. 3 is a block diagram depiction of an abbreviated channel assignment message in accordance with an embodiment of the present invention.

FIG. 4 is a logic flow diagram of steps executed by a radio access network (RAN) in accordance with an embodiment of the present invention.

FIG. 5 is a logic flow diagram of steps executed by a remote unit in accordance with an embodiment of the present invention.

### DETAILED DESCRIPTION OF EMBODIMENTS

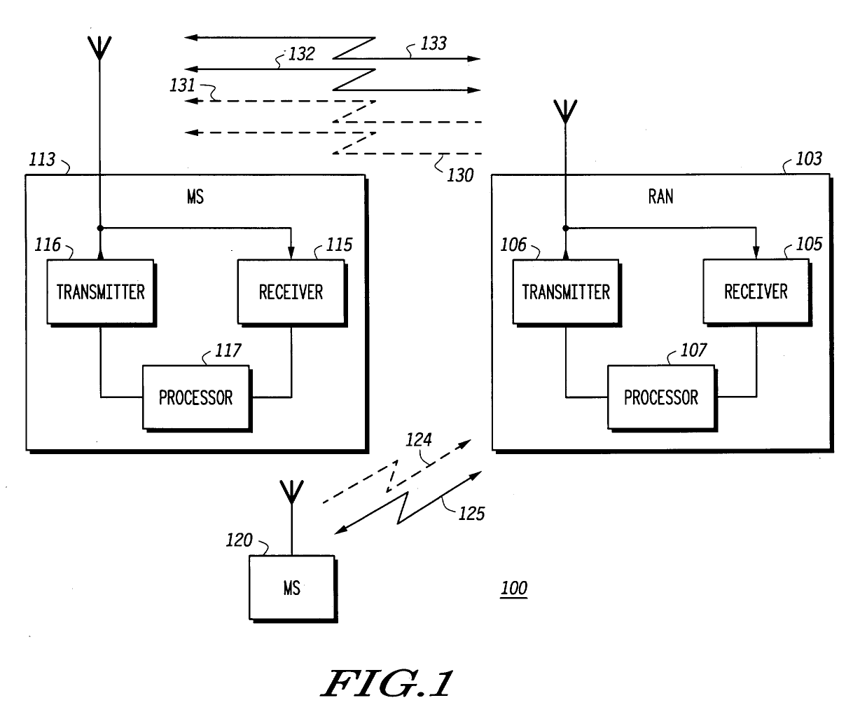

To address the need for efficiently performing channel assignment in a manner that reduces call setup time, the present embodiments provide an abbreviated channel assignment message that references information stored by a remote unit. The information that is referenced can be removed from the message. By shrinking the channel assignment message in this manner, the present embodiment allows it to be transmitted in a paging slot without negatively impacting the battery life of listening units. Thus, the reduced-call-setup-time benefit of transmitting a channel assignment message in a paging slot can be realized without trading off battery life. The present embodiment can be more fully understood with reference to FIGS. 1-5. FIG. 1 is a block diagram depiction of a communication system 100 in accordance with an embodiment of the present invention. Communication system 100 is a well-known Code Division Multiple Access (CDMA) system, specifically a CDMA 2000 system, which is based on the Telecommunications Industry Association Electronic Industries Association (TIA/EIA) standard IS-2000, suitably modified to implement the present invention. Alternative embodiments of the present invention may be implemented in communication systems that employ other technologies such as WCDMA, UMTS, GSM, GPRS, and EDGE.

The first embodiment of the present invention includes radio access network (RAN) 103 and remote units, such as mobile stations (MSs) 113 and 120. However, the present invention is not limited to remote units that are mobile. For example, a remote unit may comprise a desktop computer wirelessly connected to the radio access network. In general, throughout this document the terms “base station” (BS) and Radio Access Network (“RAN”) can be seen as synonymous. Similarly, the terms “mobile station,” “user equipment,” “mobile terminal,” “mobile unit” and “remote unit” can be seen, in general, as synonymous.

Those skilled in the art will recognize that FIG. 1 does not depict all of the network equipment necessary for system 100 to operate but only those system blocks particularly relevant to the description of embodiments of the present invention. For example, RAN 103 comprises well-known entities such as a transmitter 106, receiver 105, and controller 107. Those skilled in the art are aware of the many ways each of these entities can be implemented and/or purchased from wireless communications companies such as “MOTOROLA.” Controllers, for example, typically comprise components such as processors, memory, and/or logic circuitry designed to implement algorithms that have been expressed as computer instructions and/or in circuitry. Given an algorithm or a logic flow, those skilled in the art are aware of the many design and development techniques available to implement a controller to perform the logic.

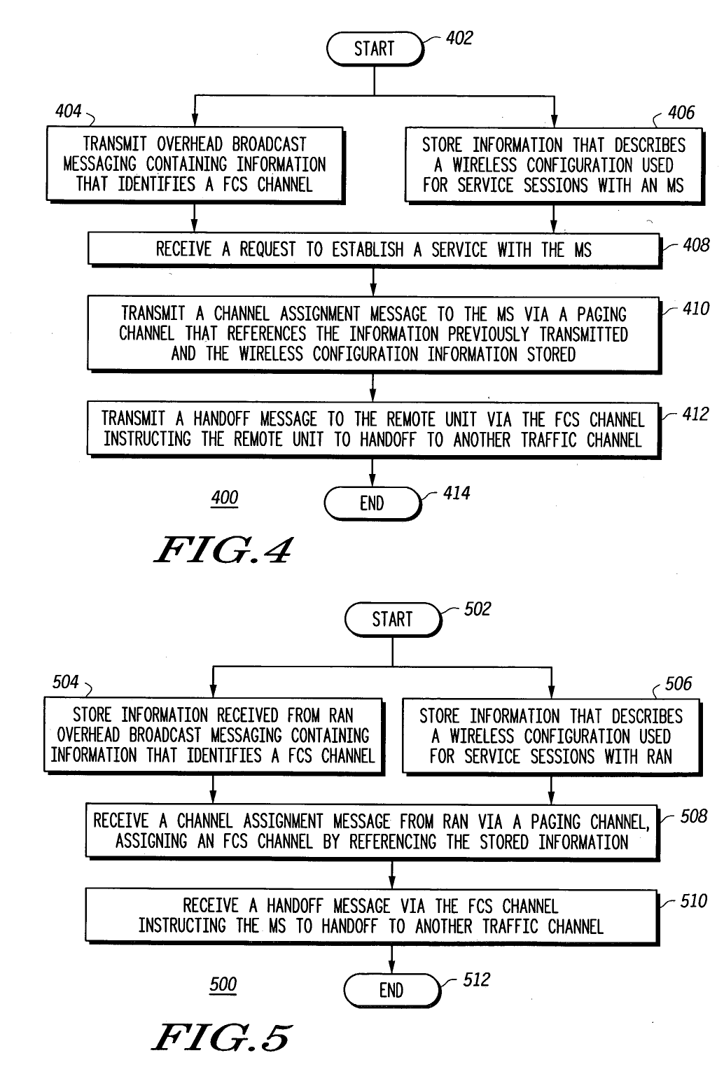

Typically, RAN transmitters and receivers are components of RAN base transceiver stations (BTSs), which interface with devices such as base site controllers, mobile switching centers/visitor location registers (MSC/VLR), home location registers (HLR), etc. In a first embodiment of the present invention, a known CDMA 2000 RAN is adapted using known telecommunications design and development techniques to implement the RAN aspect of the present invention. The result is RAN 103, which performs the method described with respect to FIG. 4. Those skilled in the art will recognize that the RAN aspect of the present invention may be implemented in and across various physical components of RAN 103.

MS 113 comprises receiver 115, transmitter 116, and processor 117 (comprising e.g., memory and processing devices). Transmitters, receivers, and processors as used in CDMA MSs are all well known in the art. This common set of MS components is adapted using known telecommunications design and development techniques to implement the remote unit aspect of the present invention. Thus modified, MS 113 performs the method described with respect to FIG. 5.

RAN 103 and MSs 113 and 120 communicate via CDMA 2000 air interface resources 124-125 and 130-133. Resource 130 comprises a paging channel, resource 124 comprises an access channel, resource 131 comprises a broadcast channel, and resources 125, 132, and 133 comprise traffic channels (TCHs).

Operation of communication system 100 in accordance with an embodiment of the present invention occurs substantially as follows. RAN 103 transmits overhead broadcast messaging containing information identifying a fast call setup (FCS) channel, specifically TCH 132. Although only FCS channel 132 is depicted, the overhead messaging will typically identify a set of TCHs as FCS channels.

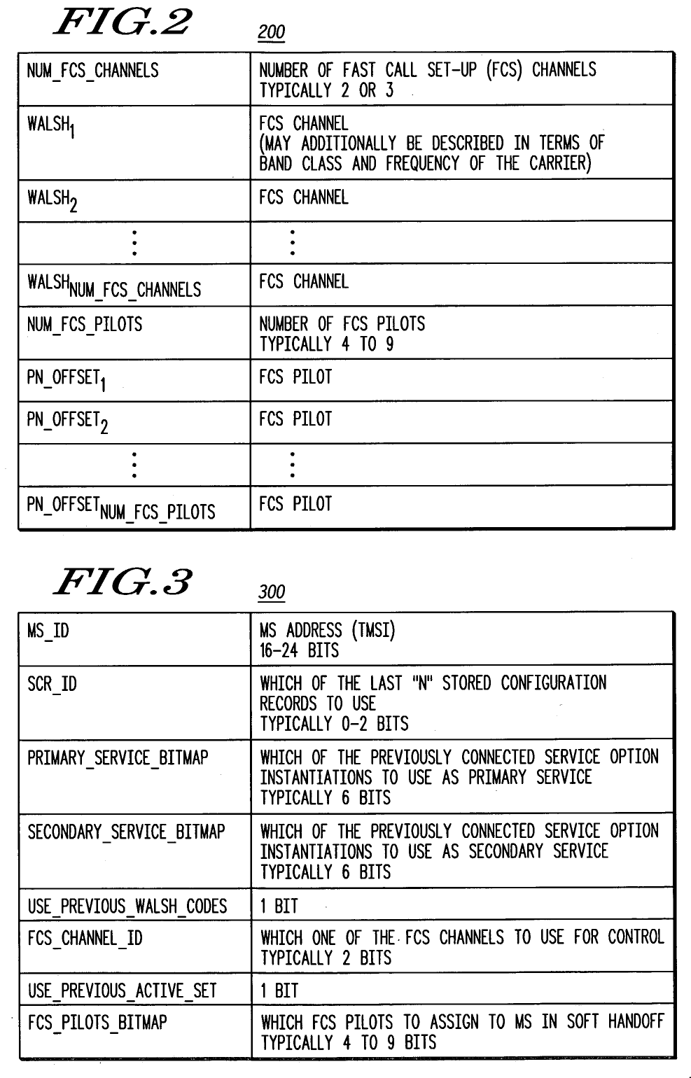

FIG. 2 is a block diagram depiction of an exemplary broadcast message 200 in accordance with an embodiment of the present invention. Broadcast message 200 first contains a field indicating how many FCS channels will be identified. The FCS channels are identified by their Walsh codes and, possibly, by Medium Access Control Id (MAC_ID) for some CDMA channels or by their pre-assigned time slot identifiers for TDMA channels. The FCS channels may alternatively be identified by their pre-assigned band class and carrier frequency.

Broadcast message 200 further contains information that identifies subsets of pilots that can be assigned in soft handoff. First, it contains a field indicating the number pilots to be identified. The pilots are then identified by their pseudo-noise (PN) offsets.

MS 113 monitors broadcast channel 131 and receives the broadcast message. MS 113 then stores the information identifying the FCS channels and pilots and their associated indexes or numbers according to the broadcast message. Thus, the FCS channels and the pilots can now be referenced by their index or number rather than their Walsh code or PN offset.

In addition to storing information received in the broadcast messaging, MS 113 and RAN 103 also store wireless configuration information from service sessions or connections involving MS 113. This configuration history, indexed from the most recent session to the oldest, generally contains basic information like the service type, Walsh codes of the channels used, PN offsets of the pilots used (a.k.a., the active set), and other relevant configuration information most needed to get a communication service started on a TCH. This would include the physical and radio channel characteristics such as the initial power level and whether the transmission is continuous or discontinuous. It would also include parameters associated with the provision of the service such as vocoder options and quality of service parameters.

In addition to storing information received in the broadcast messaging and storing configuration information from previous service sessions, MS 113 and RAN 103 also store information from MS 113's dormant state reporting. This includes channels using a set of pilots that have been reported by MS 113 to be suitable for communication. Thus, both RAN 103 and MS 113 maintain all of this channel assignment related information for later reference.

A calling unit, MS 120, transmits a service request to RAN 103 via access channel 124. As depicted in FIG. 1, RAN 103 is shown to have a single transmitter and receiver. However, as is well known, a RAN may encompass many base sites covering a wide geographic area. Thus, MSs 113 and 120 may be anywhere within RAN 103 and are certainly not limited to the same base site or location area. In fact, the calling unit may instead be a public switched telephone network (PSTN) user rather than a mobile user.

Upon receiving the service request (e.g., a dispatch service request or a packet data (re)connection request) from calling unit 120, RAN 103 begins TCH setup with MS 120 using available TCH 125. RAN 103 also needs to locate and determine the availability of target MS 113. This would normally be done by paging MS 113. However, to reduce call setup time RAN 103 assembles a channel assignment message rather than page message and pages the MS 113 by transmitting the channel assignment message rather than a page message. In effect, RAN 103 pages MS 113 with this channel assignment message by transmitting it from base sites in MS 113's location area, in paging slots that MS 113 would regularly monitor for pages.

The channel assignment message sent via paging channel 130 is an abbreviated channel assignment message. FIG. 3 is a block diagram depiction of exemplary channel assignment message 300 in accordance with an embodiment of the present invention. Channel assignment message 300 provides RAN 103 a great deal of flexibility in communicating, very succinctly, a channel and service assignment to MS 113.

Channel assignment message 300 has a first field to address MS 113 and then a number of fields RAN 103 can use to reference information both MS 113 and RAN 103 have stored. The stored information may be wireless configuration information used in a previous service session between RAN 103 and MS 113, information previously broadcast by RAN 103, or information from MS 113's dormant state reporting. Channel assignment message 300 has a second field allowing RAN 103 to indicate which of the last “n” stored configurations to use. Channel assignment message 300 has third and fourth fields allowing RAN 103 to indicate which of the last “n” stored service types to use for the primary and secondary services, respectively. The fifth field allows RAN 103 to indicate that the previous Walsh codes should be used, thereby indicating which channels MS 113 is to use. The sixth field allows RAN 103 to indicate which of the FCS channels to use, and the seventh field allows RAN 103 to indicate that the previous active set of pilots should be used. Finally, the eighth field allows RAN 103 to indicate which FCS pilots (previously identified in the overhead broadcast messaging) should be used for soft handoff.

Thus, by referring to previously stored information, the channel assignment message can be made much shorter in length. Exemplary channel assignment message 300 is less than 60 bits long. Additional information could be added, up to a total of 96 bits, without overrunning a half-frame limit on a paging channel. By shrinking the channel assignment message to such as size, the present embodiment allows it to be transmitted in a paging slot without negatively impacting the battery life of listening units. Thus, the reduced-call-setup-time benefit of transmitting a channel assignment message in a paging slot can be realized without the battery life trade-off.

FIG. 4 is a logic flow diagram of steps executed by a RAN in accordance with an embodiment of the present invention. Logic flow 400 begins (402) with the RAN transmitting (404) overhead broadcast messaging containing information that identifies a FCS channel. The RAN is also storing (406) information that describes a wireless configuration used for service sessions with a remote unit. When the RAN receives (408) a request from a calling unit to establish a service with the remote unit, the RAN transmits (410) a channel assignment message to the remote unit via a paging channel. The channel assignment message references the information previously broadcast and the wireless configuration information stored.

For the case where the remote unit is assigned to a FCS channel by the channel assignment message, the RAN transmits (412) a handoff message to the remote unit via the FCS channel instructing the remote unit to handoff to another traffic channel. This frees the FCS channel for use as a temporary TCH in a subsequent channel assignment message. Since FCS channels are identified in the broadcast messaging, they are limited in number and thus should be used only as temporary TCHs.

FIG. 5 is a logic flow diagram of steps executed by a remote unit in accordance with an embodiment of the present invention. Logic flow 500 begins (502) with the remote unit storing (504) information received from the RAN overhead broadcast messaging. This messaging contains information that identifies FCS channels. The remote unit is also storing (506) information that describes wireless configurations used for service sessions with the RAN. At some point in time, the remote unit receives (508) a channel assignment message from the RAN via a paging channel. The message assigns a channel and a service to the remote unit by referencing the stored information. For the case where the remote unit is assigned to a FCS channel, the remote unit will receive a handoff message via the FCS channel that instructs it to handoff to another traffic channel. Logic flow 500 thus ends (512).

The table below is a very detailed depiction of the information contained in FIG. 2, of a broadcast message in accordance with an embodiment of the present invention.

| | Length |
|---|---|
| Field Name | (bits) |
| ASSIGN_PAGE_INFO_INCL | 1 |
| FOR_CODE_CHAN_INCL | 0 or 1 |
| NUM_FOR_CODE_CHAN | 0 or 2 |

NUM_FOR_CHAN + 1 occurrences of the following one-field
record:

| | |
|---|---|
| FOR_CODE_CHAN | 8 |
| FOR_CPCSCH_INCL | 0 or 1 |
| NUM_FOR_CPCSCH | 0 or 2 |

NUM_FOR_CPCSCH + 1 occurrences of the following one-field
record:

| | |
|---|---|
| FOR_CPCSCH | 5 |
| MAC_ID_INCL | 0 or 1 |
| NUM_MAC_ID | 0 or 2 |

NUM_MAC_ID + 1 occurrences of the following one-field record:

| | |
|---|---|
| MAC_ID | 8 |

Field Description
ASSIGN_PAGE-

| | |
|---|---|
| _INFO_INCL | Page with abbreviated channel assignment |
| | additional information included indicator. |
| | The base station shall set this field to ‘1’ if |
| | additional information related to mobile |
| | station-addressed page with abbreviated |
| | channel assignment is included in this |
| | message; otherwise, the base station shall |
| | set this field to ‘0’. |
| FOR_CODE_CHAN_INCL | Forward code channel index information |
| | included indicator. |
| | If ASSIGN_PAGE_INFO_INCL is set |
| | to ‘0’, the base station shall omit this field; |
| | otherwise, the base station shall include |
| | this field and set it as follows: |
| | The base station shall set this field to ‘1’ if |
| | at least one occurrence of the |
| | FOR_CODE_CHAN field is included |
| | in this message; otherwise, the base station |
| | shall set this field to ‘0’. |
| NUM_FOR_CODE_CHAN | Number of code channel indexes. |
| | If FOR_CODE_CHAN_INCL is set |
| | to ‘0’, the base station shall omit this field; |
| | otherwise, the base station shall include |
| | this field and set it to the number of |
| | occurrences of the FOR_CODE_CHAN |
| | field included in this message minus one. |

If NUM_FOR_CODE_CHAN is included in this message, then the
base station shall include NUM_FOR_CODE_CHAN + 1
occurrences of the following one-field record:

| | |
|---|---|
| FOR_CODE_CHAN | Forward code channel index. |
| | The base station shall set this field to the |
| | code channel index (see [2]) that can be |
| | assigned using a mobile-addressed page |
| | with abbreviated channel assignment. |
| | If Radio Configuration 1, 2, 3, or 5 (see |
| | [2]) is used, the base station shall set this |
| | field in the range 1 to 63 inclusive. If |
| | Radio Configuration 4, 6 or 8 is used, the |
| | base station shall set this field in the |
| | range 1 to 127 inclusive. If Radio Con- |
| | figuration 7 or 9 is used, the base station |
| | shall set this field in the range 1 to 255 |
| | inclusive. |
| FOR_CPCSCH_INCL | Forward Common Power Control Channel |
| | Subchannel information included |
| | indicator. |
| | If ASSIGN_PAGE_INFO_INCL is set |
| | to ‘0’, the base station shall omit this field; |
| | otherwise, the base station shall include |
| | this field and set it as follows: |
| | The base station shall set this field to ‘1’ if |
| | at least one occurrence of the |
| | FOR_CPCSCH field is included in this |
| | message; otherwise, the base station shall |
| | set this field to ‘0’. |
| NUM_FOR_CPCSCH | Number of Forward Common Power |
| | Control Channel Subchannels. |
| | If FOR_CPCSCH_INCL is set to ‘0’, the |
| | base station shall omit this field; |
| | otherwise, the base station shall include |
| | this field and set it to the number of |
| | occurrences of the FOR_CPCSCH field |
| | included in this message minus one. |

If NUM_FOR_CPCSCH is included in this message, then the base
station shall include NUM_FOR_CPCSCH + 1 occurrences of the
following one-field record:

| | |
|---|---|
| FOR_CPCSCH | Forward Common Power Control Channel |
| | Subchannel. |
| | The base station shall set this field to the |
| | Forward Common Power Control Channel |
| | Subchannel that can be assigned using |
| | a mobile-addressed page with abbreviated |
| | channel assignment. |
| MAC_ID_INCL | MAC index information included |
| | indicator. |
| | If ASSIGN_PAGE_INFO_INCL is set |
| | to ‘0’, the base station shall omit this field; |
| | otherwise, the base station shall include |
| | this field and set it as follows: |
| | The base station shall set this field to ‘1’ if |
| | at least one occurrence of the MAC_ID |
| | field is included in this message; |
| | otherwise, the base station shall set |
| | this field to ‘0’. |
| NUM_MAC_ID | Number of Medium Access Control |
| | indexes. |
| | If MAC_ID_INCL is set to ‘0’, the base |
| | station shall omit this field; otherwise, |
| | the base station shall include this field |
| | and set it to the number of occurrences of |
| | the MAC_ID field included in this |
| | message minus one. |

If NUM_MAC_ID is included in this message, then the base station
shall include NUM_MAC_ID + 1 occurrences of the following
one-field record:

| | |
|---|---|
| MAC_ID | Medium Access Control index. |
| | The base station shall set this field to the |
| | Medium Access Control index that can be |
| | assigned using a mobile-addressed page |
| | with abbreviated channel assignment. |

The tables below provide a very detailed depiction of the information contained in FIG. 3, of an abbreviated channel assignment message in accordance with an embodiment of the present invention.

PDU Format for a mobile station-addressed page with abbreviated channel assignment:

| | Length |
|---|---|
| Field | (bits) |
| RESPONSE_IND | 2 |
| SR_ID_RESTORE | 3 |
| USE_PREV_ACTIVE_SET | 1 |
| FOR_CHAN_ID | 2 |
| MAC_ID_ID | 2 |
| Additional record fields | 4 |

If USE_PREV_ACTIVE_SET = ‘0’, the additional record fields
shall be:

| | |
|---|---|
| NEW_ACTIVE_SET | 2 |

If USE_PREV_ACTIVE_SET = ‘1’, the additional record fields
shall be:

| | |
|---|---|
| USE_PREV_FOR_CHAN | 1 |
| USE_PREV MAC_ID | 1 |

| | |
|---|---|
| CONFIG_MSG_SEQ | Configuration message sequence number. |
| | The base station shall set this field to |
| | CONFIG_SEQ (see 3.6.2.2). |
| [. . .] | |
| ADD_BCAST_RECORD | Additional broadcast information record. |
| | The base station shall omit this field if |
| | EXT_BCAST_SDU_LENGTH_IND (see |
| | [4]) is set to ‘00’ or ‘01’; otherwise, the base |
| | station shall include |
| | EXT_BCAST_SDU_LENGTH (see [4]) |
| | octets in this field. |
| RESPONSE_IND | Response requested indicator. |
| | The base station shall set this field according |
| | to Table 3.7.2.3.2.17-1. |

TABLE 3.7.2.3.2.17-1
RESPONSE_IND values

| RESPONSE_IND | | Response |
|---|---|---|
| (binary) | Response (accept) | (reject) |
| 00 | The mobile station is not to | The mobile |
| | respond on the r-csch. | station is to |
| 01 | The mobile station is to respond | respond with |
| | with a Page Response Message in | a Mobile |
| | unassured mode on the r-csch. | Station Reject |
| 10 | The mobile station is to respond | Order with |
| | with a Page Response Message in | ORDQ equal |
| | assured mode on the r-csch. | to ‘00000111’ |
| 11 | Reserved. | |

| | |
|---|---|
| SR_ID_RESTORE | Service reference identifier to be restored. |
| | The base station shall set this field to |
| | ‘111’ if the mobile station is to restore all |
| | the service option connections from the |
| | stored service configuration; otherwise, |
| | the base station shall set this field to the |
| | service reference identifier corresponding |
| | to the service option connection to be |
| | restored. |
| USE_PREV_ACTIVE_SET | Use previous Active Set indicator. |
| | The base station shall set this field to ‘1’ |
| | to indicate that the mobile station's Active |
| | Set on the Traffic Channel is to be the |
| | same as that stored by the mobile station |
| | when it left the Mobile Station Control on |
| | the Traffic Channel State; otherwise, the |
| | base station shall set this field to ‘0’. |
| | FOR_CHAN_ID - Forward code channel |
| | or F-CPCSCH identifier. |
| | If USE_PREV_ACTIVE_SET is equal |
| | to ‘0’, or USE_PREV_ACTIVE_SET |
| | is equal to ‘1’ and |
| | USE_PREV_FOR_CHAN is equal to |
| | ‘0’, then the base station shall set this |
| | field as follows: |
| | If a Forward Fundicated Channel is |
| | assigned, the base station shall set this |
| | field to the identifier corresponding to the |
| | walsh code of the Forward Traffic |
| | Channel associated with |
| | FPC_PRI_CHAN assigned to the mobile |
| | station on all pilots. |
| | If a Forward Fundicated Channel is not |
| | assigned, the base station shall set this |
| | field to the identifier corresponding to the |
| | Forward Common Power Control Channel |
| | Subchannel assigned to the mobile station |
| | on all pilots. |
| | Otherwise, the base station shall set this |
| | field to ‘00’. |
| MAC_ID_ID | Medium access control index identifier. |
| | If a Forward Packet Data Channel is not |
| | assigned, or USE_PREV_ACTIVE_SET |
| | is equal to ‘1’ and |
| | USE_PREV_MAC_ID is equal to ‘1’, |
| | then the base station shall set this field |
| | to ‘00’. |
| | Otherwise, the base station shall set this |
| | field to the identifier corresponding to the |
| | MAC index assigned to the mobile station |
| | on all pilots. |

If USE_PREV_ACTIVE_SET is equal to ‘0’, then the base station
shall include the following four-field record:

| | |
|---|---|
| NEW_ACTIVE_SET | New Active Set. |
| | The base station shall set this field |
| | according to Table 3.7.2.3.2.17-2. |

TABLE 3.7.2.3.2.17-2
NEW_ACTIVE_SET values

| NEW_ACTIVE_SET | |
|---|---|
| (binary) | Active Set |
| 00 | The mobile station is to use the first (i.e. |
| | strongest) pilot reported in the last Radio |
| | Environment Report Message as the Active |
| | Set on the Traffic Channel. |
| 01 | The mobile station is to use the second pilot |
| | reported in the last Radio Environment |
| | Report Message as the Active Set on the |
| | Traffic Channel. |
| 10 | The mobile station is to use the first two |
| | pilots reported in the last Radio |
| | Environment Report Message as the Active |
| | Set on the Traffic Channel. The Forward |
| | Traffic Channel associated with each pilot |
| | do not carry the same closed-loop power |
| | control subchannel bits. |
| 11 | The mobile station is to use the first two |
| | pilots reported in the last Radio |
| | Environment Report Message as the Active |
| | Set on the Traffic Channel. The Forward |
| | Traffic Channel associated with each pilot |
| | carry the same closed-loop power control |
| | subchannel bits. |

If USE_PREV_ACTIVE_SET is equal to ‘1’, then the base station
shall include the following three-field record:

| | |
|---|---|
| USE_PREV_FOR_CHAN | Use previous forward code channel or |
| | F-CPCSCH indicator. |
| | The base station shall set this field to ‘1’ |
| | to indicate that the mobile station's |
| | Forward Fundicated Channel walsh code |
| | or Forward Common Power Control |
| | Channel Subchannel is to be the same as |
| | that stored by the mobile station when it |
| | left the Mobile Station Control on the |
| | Traffic Channel State; otherwise, the base |
| | station shall set this field to ‘0’. |
| USE_PREV_MAC_ID | Use previous MAC index indicator. |
| | The base station shall set this field to ‘1’ |
| | to indicate that the mobile station's MAC |
| | index is to be the same as that stored by |
| | the mobile station when it left the Mobile |
| | Station Control on the Traffic Channel |
| | State; otherwise, the base station shall set |
| | this field to ‘0’. If the Forward Packet |
| | Data Channel is not assigned, then the |
| | base station shall set this field to ‘0’. |

While the present invention has been particularly shown and described with reference to particular embodiments thereof, it will be understood by those skilled in the art that various changes in form and details may be made therein without departing from the spirit and scope of the present invention.

What is claimed is:

1. A method for a base site to perform efficient channel assignment comprising:
transmitting overhead broadcast messaging containing information that identifies a fast call setup (FCS) channel;
receiving a request to establish a service with the remote unit; and
transmitting a channel assignment message to the remote unit via a paging channel in response to the request, wherein the channel assignment message assigns the remote unit to the FCS channel and the service by referencing the information previously transmitted.

2. The method of claim 1, wherein the FCS channel comprises a traffic channel.

3. The method of claim 1, wherein transmitting the channel assignment message comprises:
assembling the channel assignment message rather than assembling a page message for the remote unit; and
paging the remote unit by transmitting in a monitored paging slot of the remote unit the channel assignment message rather than a page message.

4. The method of claim 1, wherein transmitting overhead broadcast messaging containing information that identifies the FCS channel comprises transmitting overhead broadcast messaging containing a Walsh code identifying the FCS channel.

5. The method of claim 1, wherein transmitting overhead broadcast messaging containing information that identifies the FCS channel comprises transmitting overhead broadcast messaging containing a time slot identifier identifying the FCS channel.

6. The method of claim 1, wherein transmitting overhead broadcast messaging containing information that identifies the FCS channel comprises transmitting overhead broadcast messaging containing a band class and carrier frequency identifying the FCS channel.

7. The method of claim 1, wherein the overhead broadcast messaging further contains information that identifies pilots for soft handoff.

8. The method of claim 1, wherein the channel assignment message comprises an indication of which soft handoff pilots identified in the overhead broadcast messaging the remote unit is to use.

9. The method of claim 1, wherein the channel assignment message comprises an indication to use a set of pilots previously received from the remote unit, wherein the set of pilots were indicated as suitable for communication.

10. The method of claim 1, further comprising storing information that describes a wireless configuration used for service sessions with the remote unit, wherein the channel assignment message further references wireless configuration information used for a previous service session with the remote unit.

11. The method of claim 1, further comprising transmitting a handoff message to the remote unit via the FCS channel that instructs the remote unit to handoff to another traffic channel.

12. A method for a base site to perform efficient channel assignment comprising:
storing information that describes a wireless configuration used for service sessions with a remote unit;
receiving a request to establish a service with the remote unit; and
transmitting a channel assignment message to the remote unit via a paging channel in response to the request, wherein the channel assignment message assigns the remote unit to a traffic channel and the service by referencing wireless configuration information used for a previous service session with the remote unit.

13. The method of claim 12, wherein the traffic channel comprises a dedicated fast call setup (FCS) channel.

14. The method of claim 12, further comprising:
storing information received in a remote unit report; and
referencing information received in the remote unit report in the channel assignment message.

15. The method of claim 12, wherein transmitting the channel assignment message comprises:
assembling the channel assignment message rather than assembling a page message for the remote unit; and
paging the remote unit by transmitting in a monitored paging slot of the remote unit the channel assignment message rather than a page message.

16. The method of claim 12, wherein the information that describes a wireless configuration comprises information selected from the group consisting of an active set of soft handoff pilots, a communication service type, and Walsh codes.

17. The method of claim 12, wherein the information that describes a wireless configuration comprises information selected from the group consisting of physical and radio channel characteristics, a communication service type, and parameters associated with provisioning a service of the communication service type.

18. The method of claim 12, wherein the channel assignment message comprises an indication for the remote unit to use at least one configuration element selected from the group consisting of a previously stored wireless configuration, a previously stored service, and previously used Walsh codes.

19. A method for a remote unit to facilitate efficient channel assignment comprising:
receiving from a radio access network (RAN) overhead broadcast messaging containing information that identifies a fast call setup (FCS) channel;
storing the information that identifies the FCS channel; and
receiving a channel assignment message from the RAN via a paging channel, wherein the channel assignment message assigns the remote unit to the FCS channel and a service by referencing the information that identifies the FCS channel.

20. A method for a remote to facilitate efficient channel assignment comprising:
storing information that describes a wireless configuration used for service sessions with a radio access network (RAN);
receiving a channel assignment message from the RAN via a paging channel, wherein the channel assignment message assigns the remote unit to a traffic channel and a service by referencing wireless configuration information used for previous service sessions with the remote unit.

21. A radio access network (RAN) comprising:
a transmitter;
a receiver; and
a controller, coupled to the transmitter and receiver, adapted to instruct the transmitter to transmit overhead broadcast messaging containing information that identifies a fast call setup (FCS) channel, adapted to store information that describes a wireless configuration used for service sessions with a remote unit, adapted to receive via the receiver a request to establish a service with the remote unit, and adapted to instruct the transmitter to transmit a channel assignment message to the remote unit via a paging channel in response to the request, wherein the channel assignment message assigns the remote unit to a traffic channel and the service by referencing at least one of the information previously transmitted and wireless configuration information used for a previous service session with the remote unit.

22. A remote unit comprising:
a receiver;
a transmitter; and
a processor, coupled to the transmitter and receiver, adapted to receive, via the receiver from a radio access network (RAN), overhead broadcast messaging containing information that identifies a fast call setup (FCS) channel, adapted to store the information that identifies the FCS channel, adapted to store information that describes a wireless configuration used for service sessions with the RAN, and receive via the receiver a channel assignment message from the RAN via a paging channel, wherein the channel assignment message assigns the remote unit to a traffic channel and a service by referencing at least one of wireless configuration information used for previous service sessions with the remote unit and the information that identifies a FCS channel.
